(19) United States
(12) Patent Application Publication
(10) Pub. No.: US 2014/0255296 A1
(43) Pub. Date: Sep. 11, 2014

(54) METHOD FOR OBTAINING HYDROGEN BY CATALYTIC DECOMPOSITION OF FORMIC ACID

(71) Applicants: Matthias Beller, Ostseebad Nienhagen (DE); Ralf Jackstell, Cuxhaven (DE); Heinrik Junge, Rostock (DE); Felix Gärtner, Haltern Am See (DE); Albert Boddien, Itzehoe (DE); Doerthe Mellmann, Rostock (DE)

(72) Inventors: Matthias Beller, Ostseebad Nienhagen (DE); Ralf Jackstell, Cuxhaven (DE); Heinrik Junge, Rostock (DE); Felix Gärtner, Haltern Am See (DE); Albert Boddien, Itzehoe (DE); Doerthe Mellmann, Rostock (DE)

(73) Assignee: Bayer Technology Services GmbH, Leverkusen (DE)

(21) Appl. No.: 14/111,872

(22) PCT Filed: Apr. 18, 2012
(86) PCT No.: PCT/EP12/57044

§ 371 Date: Feb. 4, 2014

(30) Foreign Application Priority Data
Apr. 19, 2011 (DE) 10 2011 007 661.1

(51) Int. Cl. C01B 3/22

(52) U.S. Cl. CPC C01B 3/22
USPC 423/648.1

(57) ABSTRACT

The invention relates to a method for producing hydrogen by selective dehydration of formic acid using a catalytic system consisting of a transition metal complex of transition metal salt and at least one tripodal, tetradentate ligand, wherein the transition metal is selected from the group comprising Ir, Pd, Pt, Ru, Rh, Co and Fe. The transition metal complex can be used either as a homogeneous catalyst or a heterogenised metal complex, which has been applied to a carrier.

### CROSS-REFERENCE TO RELATED APPLICATIONS

This application is a national stage application (under 35 U.S.C. §371) of PCT/EP2012/057044, filed Apr. 18, 2012, which claims benefit of German application 10 2011 007 661.1, filed Apr. 19, 2011.

The invention relates to a process for producing hydrogen by selective dehydrogenation of formic acid using a catalytic system based on a transition metal complex derived from a transition metal salt and at least one tripodal tetradentate ligand, where the transition metal is selected from the group consisting of Ir, Pd, Pt, Ru, Rh, Co and Fe. The transition metal complex can be used either as a homogeneous catalyst or a heterogenized metal complex which has been applied to a support.

### PRIOR ART

Possible energy stores include not only electric stores (batteries), mechanical stores (pump stores) and thermal stores (power-heat coupling usually water stores) but also chemical stores. Among chemical stores, there has been a great deal of discussion about, in particular, methane (natural gas, CH₄) and hydrogen.

Hydrogen (H₂) is a gas which even today is used in many chemical reactions (e.g. Haber-Bosch process, Fischer-Tropsch process). In addition, H₂ can provide energy by reaction in internal combustion engines, chemical reactors or fuel cells. Owing to the clean combustion of hydrogen to form water, this energy store occupies a special position. For this reason, too, hydrogen technology will in future play a key role with regard to a sustainable energy supply.

However, a fundamental problem is still storage of hydrogen. The gas hydrogen is extremely volatile, highly inflammable and highly explosive in mixtures with oxygen gas (air). A hydrogen store which allows safe and easy handling of this gas is therefore of critical importance. In addition, the amount of hydrogen liberated should be restricted to the amount directly required. A preparation of hydrogen, with immediate start-up, is therefore a process to be preferred.

For the storage of hydrogen, there has been discussion of not only the “classical” methods (pressurized gas stores, liquefied gas stores, metal hydride stores) but currently also of various organic hydrogen-rich compounds. These include, for example, methanol, organic “hydrides” such as decalins or methylcyclohexane and also formic acid. The latter is in the form of a liquid at from 8 to 101° C., contains 4.4% by weight of H₂ and is nontoxic. Formic acid is thus a comparatively easy-to-handle hydrogen store. To be able to utilize the hydrogen present in the formic acid, the formic acid has to be selectively decomposed into hydrogen and carbon dioxide. This is successful only in the presence of a suitable catalyst.

First catalysts for the dehydrogenation of formic acid were described by Sabatier in 1912. Since this time, numerous catalytic systems for the selective dehydrogenation of formic acid have been described.

Heterogeneous catalysts are described, for example, in a publication by Williams and co-workers [R. Williams, R. S. Crandall, A. Bloom, Appl. Phys. Lett. 1978, 33, 381]. A Pd/C (1% by weight of Pd) catalyst is used. In this way, about 55 ml of hydrogen could be prepared from a 4 molar aqueous formic acid solution (4M) over a period of 10 minutes.

More recent research results of Xing et al. [X. Zhou, Y. Huang, C. Liu, J. Liau, T. Lu, W. Xing, ChemSusChem 2010, 3, 1379] show that good activities can be achieved at 92° C. using Pd@Au catalysts. Thus, up to 1.198 liters of gas (H₂+CO₂) per minute and gram of catalyst could be produced. Overall, about 36 ml of gas could thus be evolved in the experiments, which is a number of orders of magnitude too little for industrial implementation. The gas mixture additionally contained over 30 ppm of CO, which makes gas purification necessary for direct use in a PEM fuel cell (requirements: CO<10 ppm).

The catalyst systems described in the publications cited by way of example are still very far from possible usability because of the high temperatures of >100° C. required, the low selectivities (high CO content) and low activities (few ml of hydrogen were generated per minute).

In WO 2008059630 A1, Fukuzumi et al. describe, for example, a heterobinuclear catalyst based on iridium. In illustrative reactions, the catalyst provided hydrogen (+CO₂) selectively from aqueous formic acid solution over a period of 25 minutes. In particular, the catalyst and many derivatives of the heterobinuclear catalyst are described in the manuscript. However, none of the heterobinuclear catalyst systems examined to date even approximately meet the minimum requirements, in particular in respect of activity and selectivity, for industrial use.

Significantly higher activities and selectivities at lower temperatures have hitherto been able to be observed in the case of homogeneous catalyst systems.

The group around Himeda et al. was able to develop a catalyst which is based on the noble metal iridium and combined comparatively high activities and good selectivities with a stability sufficient for the laboratory scale. At a temperature of 90° C., they achieved a turnover frequency (TOF) of 14 000 h⁻¹ using a HCO₂H/HCO₂Na mixture. At low temperatures, no appreciable conversions were able to be observed [Y. Himeda, Green Chem. 2009, 11, 2018].

Industrially interesting homogeneous catalyst systems are based essentially on noble metal complexes. In 2008, Laurenczy et al. and Beller et al. independently developed the concept of storage of hydrogen in the form of formic acid. Based on their experiences in the hydrogenation of carbonates, Laurenczy et al. utilized a water-soluble ruthenium-TPPTS (tris-m-sulfonated triphenylphosphine trissodium salt) complex which can liberate hydrogen from an aqueous HCO₂H/HCO₂Na solution (9:1) at from 70° C. to 120° C. However, the activity of the catalyst decreases dramatically at temperatures below 70° C. (EP 1 918 247 A1).

Wills and co-workers utilized the ruthenium-based catalyst [RuCl₂(DMSO)] in order to produce up to 1.4 l of gas (H₂+CO₂) per minute at 120° C. from a formic acid/dimethyloctylamine mixture. Using triethylamine as base, up to 2.5 l of gas (H₂+CO₂) per minute could briefly be produced, but at this temperature a major part of the amine used was carried out from the process together with the gas liberated. The high temperature required and the need to utilize a base (here amines) make this process uninteresting for practical use [D. J. Morris, G. J. Clarkson, M. Wills, Organometallics 2010, 132, 1496].

Beller et al. examined heterogeneous and homogeneous catalyst systems based on Pd, Rh, Ir, Ru, Cr, Mn, Fe, Co, Ni, Cu and Mo. Within this broad screening, Ru and Fe catalysts, in particular, were examined in detail for the preparation of hydrogen from formic acid in a mixture with amines. Thus, for example, a system consisting of [RuBr₃]xH₂O together with PPh₃ displayed activities of up to 3630 h⁻¹ TOF (turnover frequency) at 40° C.

The further-developed catalyst [RuCl₂ (benzene)]/dppe in 5HCO₂H/4HexNMe₂ is to date the most active catalyst at temperatures below 80° C. With a TOF of 900 h⁻¹ at 25° C. and a conversion of 100%, this catalyst system is the hitherto most active for the selective decomposition of formic acid into H₂ and CO₂. As regards the development of a biological catalysis system for the selective dehydrogenation of formic acid, only a few catalysts which are not based on noble metals are known [A. Boddien, B. Loges, F. Gärtner, C. Torborg, K. Fumino, H. Junge, R. Ludwig, M. Beller, J. Am. Chem. Soc. 2010, 132, 8924; A. Boddien, F. Gäartner, R. Jackstell, H. Junge, A. Spannenberg, W. Baumann, R. Ludwig, M. Beller, Angew. Chem. 2010, 122, 9177-9181]. However, all catalysis systems tested were active only in the presence of visible light and bases (triethylamine, NEt₃).

Noble metal-containing catalysts have the disadvantage that they are costly, so that more inexpensive alternatives are sought, with base metal catalysts, e.g. iron catalysts, being possibilities. On irradiation with light, an in situ catalyst system consisting of Fe₃(CO)₁₂/PPh₃/tpy displays significant activity for the selective generation of hydrogen from FA/TEA mixtures. Activity and stability were increased by means of a system having tribenzylphosphane (PBn₃) instead of PPh₃. Thus, it was possible to prepare over 3.7 liters of gas (H₂+CO₂) in a period of 51 hours, which corresponds to a turnover number (TON) of 1266. These are to date the only catalyst systems based on the cheap metal iron to be examined. They are summarized in a review (Boddien, Albert, Gäartner, Felix, Mellmann, Dörthe, Kammer, Anja, Losse, Sebastian, Marquet, Nicolas, Surkus, Annette-Enrica, Rajenahally, Jagadeesh, Junge, Henrik, Beller, Matthias, Loges, Björn, GIT 2010, 8, 576). The iron-based catalyst systems are not industrially practicable and do not come into question for use because of the activities achieved and a selectivity of about 10 000 ppm of CO and more.

None of the catalyst systems (homogeneous or heterogeneous) described hitherto meets the conditions linked to industrial implementation. High temperatures (>100° C.) and/or the presence of a base (NaHCO₂ or amines) or a precisely set pH of the solution are always necessary to achieve sufficient activity. In addition, only few catalysts meet the selectivity requirements (<10 ppm of CO).

It was therefore an object of the invention to seek inexpensive industrially usable catalyst systems for obtaining hydrogen from formic acid, which catalyst systems achieve high activities and operate under simple reaction conditions, preferably at room temperature. The reaction must be highly selective in order to avoid dehydration (H₂O+CO) since, for example, fuel cells which operate using hydrogen gas tolerate only small amounts of CO.

### A BRIEF DESCRIPTION OF THE FIGURES

FIG. 1 shows an illustrative experiment according to example 9 of the invention.

FIG. 2 shows an illustrative experiment according to example 10 of the invention.

### DESCRIPTION OF THE INVENTION

The invention describes the use of transition metal complexes as catalysts in order to decompose formic acid highly selectively into hydrogen and carbon dioxide at low (≦100° C.) temperatures and preferably under atmospheric pressure (1 bar). The process of the invention is characterized in that hydrogen is liberated selectively from formic acid at temperatures of from 0° C. to 100° C. using a catalyst system which consists of a transition metal salt and a tripodal tetradentate ligand, where the transition metal is selected from the group consisting of Ir, Pd, Pt, Ru, Rh, Co and Fe. This catalytic system can be used as homogeneous or heterogenized metal complex and does not require any further auxiliaries (e.g. bases, amines) or specific toxic solvents, nor high temperatures. The content of carbon monoxide in the gas mixture is below the required threshold for direct combustion in H₂/O₂ PEM fuel cells.

The invention described leads to selective liberation of hydrogen and carbon dioxide in a ratio of 1:1 (H₂:CO₂=50:50% by volume) from formic acid. A virtually pure H₂/CO₂ mixture can be obtained in the low to medium temperature range by means of the catalyst system. As mentioned above, no specific auxiliaries or specific reaction conditions (e.g. pH) are necessary for this reaction. In addition, biodegradable solvents, for example, can be used when the catalyst system is used as a homogeneous system. Furthermore, the catalyst system used displays a high activity and stability. In addition, the reaction can be controlled in respect of gas evolution by selection of the temperature, of the pressure, irradiation with light and/or amount of formic acid.

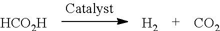

The catalyst can be separated off after a reaction and be reused. The catalyst is stable over a wide temperature and pressure range, in particular under acidic conditions (pKa of formic acid=3.77).

The reaction surprisingly takes place even at low temperatures of about 0° C., with constant hydrogen evolution occurring. The reaction temperatures should generally be in the range from 20 to 100° C. The temperature range from 25 to 80° C. is to be preferred. The temperature range from 40 to 80° C. is most preferred. Hydrogen can be generated highly selectively from formic acid over the entire temperature range proposed. Here, the formic acid is quantitatively converted into hydrogen and carbon dioxide.

The temperature plays a critical role for the activity of the reaction. Since the reaction also proceeds at room temperature (˜20-25° C.), the required heat of reaction can be withdrawn from the surroundings. Should a higher activity be desired, the temperature of the reaction space can be increased appropriately, preferably by means of a heating unit. This heating unit can be an oil bath, electric heating element, water bath or heat exchanger, etc. The waste heat of a connected fuel cell can advantageously be utilized.

Fundamentally, no additional bases, e.g. amines, are required for the dehydrogenation of formic acid using the catalyst system according to the invention, but formates, e.g. NaHCO₂, can optionally be added. The amount of base used should not exceed an HCO₂⁻/HCO₂H ratio of 1:1. The formate salt can be any salt. The cation can be an organic or inorganic cation. The cation is preferably an inorganic cation, particularly preferably with metallic character. For example, the cation can be a sodium, Mg or calcium ion.

The process can also be used for cooling by a heat exchanger (including a suitable medium) connecting the reaction unit to another object.

The decomposition of formic acid can, when the reaction space is closed, generate a defined pressure. The reaction can be carried out at various pressures. The pressure range prevailing during operation can be from 1 to 200 bar, preferably 1-10 bar.

The catalyst system described can consist of a catalyst generated in situ, metal source and ligand, or a previously synthesized metal complex. Preference is given to using, according to the invention, a catalyst system which is a metal complex consisting of a cation and anion or a neutral metal complex having the general formula (Ia) or (Ib),

[M(X)ₘ(L)ₙ]⁺Y⁻ (Ia)

M(X)ₘ(L)ₙ (Ib)
In these formulae, M, X, L, m and n have the following meanings:
M is a transition metal selected from the group consisting of Ir, Pd, Pt, Ru, Rh, Co and Fe. M is preferably Ru, Co or Fe.
X is selected from the group consisting of N₂, H₂, H, CO, CO₂, H₂O, halide, acetylacetonate (acac⁻), perchlorate (ClO₄²⁻) and sulfate (SO₄²⁻), formate (HCO₃⁻),
m is 1, 2, 3, 4, 5 or 6; preferably 1, 2 or 3;
n is 1 or 2.
L is a tripodal ligand of the general formula (II):

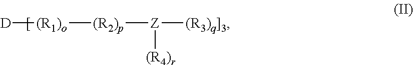

where
   D and Z are identical or different and are each selected from the group consisting of N, O, P and S;
   o, p=0, 1, 2 or 3;
   R₁, R₂ are identical or different and are each selected from the group consisting of alkyl (C1-C6), cycloalkyl (C3-C10) and aryl.
   R₃, R₄ are identical or different and are each selected from the group consisting of alkyl (C1-C6), cycloalkyl (C3-C10), aryl and heteroaryl; q, r=1 or 2;
   where D and/or Z can be coordinated to the metal.
Y⁻ is a monovalent anion selected from the group consisting of halides, P(R)₆⁻, S(R)₆⁻, B(R)₄⁻, where R is an alkyl (C1-C6), cycloalkyl (C3-C6), aryl or halogen radical, triflate and mesylate anions. Preference is given to Y⁻═BF₄⁻ or BPh₄⁻.

Halogen or halides encompasses Cl, F, Br and I.

As examples of alkyl groups, it is possible for methyl, ethyl, n-propyl, isopropyl, n-butyl, sec-butyl, tert-butyl, n-pentyl and n-hexyl to occur. As examples of cycloalkyl groups, mention may be made of cyclopropyl, cyclobutyl, cyclopentyl and cyclohexyl.

The term aryl refers, for the purposes of the invention, to aromatic ring systems which can be phenyl, naphthyl, phenanthrenyl and anthracenyl.

The term heteroaryl refers to heteroaromatic ring systems which can be five-membered and six-membered heterocycles in which at least one carbon atom has been replaced by nitrogen, oxygen and/or sulfur, preferably pyridine, quinoline, pyrimidine, quinazoline, furan, pyrazole, pyrrole, imidazole, oxazole, thiophene, thiazole, triazole.

Particular preference is given to metal complexes in which M is Ru, Co or Fe, particularly preferably Fe. m is preferably 1 or 2. n is preferably 1.

Preferred ligands of the general formula (II) are those in which D is nitrogen (N) or phosphorus (P). Z is preferably phosphorus (P).

R₁, R₂ are identical or different and are preferably selected from the group consisting of alkyl (C1-C6) and phenyl. o and p arc preferably 0 or 1, where at least o or p=1.

R₃ and R₄ are preferably phenyl. q and r are preferably 1.

Y⁻ is preferably BF₄⁻ or BPh₄⁻.

The ligand to be used is preferably a tetradentate ligand which is coordinated to the metal center. The greatest preference is given to the ligands
a) tetraphos [PP₃—(II) D and Z═P, R₁ and R₂═CH₂ and o and p=1 and also R₃, R₄=phenyl and q=1, r=1],
b) tris(2-(diphenylphosphino)phenyl)phosphine, [L1—(II) D and Z═P, R₁=phenyl and o=1, p=0, and also R₃, R₄=phenyl and q=1, r=1],
c) tris(2-(diphenylphosphino)benzyl)phosphine, [L2—(II) D and Z═P, R₁=phenyl and R₂═CH₂, o=1, p=1, and also R₃, R₄=phenyl and q=1, r=1], and
d) tris((diphenylphosphino)methyl)amine, [L3—(II) D=N and Z═P, R₁═CH₂ and o=1, p=0, and also R₃, R₄=phenyl and q=1, r=1].

The catalyst can be formed in situ from a suitable metal source and a suitable ligand, or can be a previously prepared defined metal complex.

If the complex is to be generated in situ, a metal source is used as precatalyst together with a ligand of the general formula (II).

Preference is given to using an iron source, Fe(0), Fe(II) or Fe(III), as metal source and a ligand of the general formula (II). Fe sources can be, for example, Fe(acac)₂; Fe(acac)₃; Fe(ClO₄)₂, Fe(ClO₄)₃ or Fe(BF₄)₂×6 H₂O. As Co source, preference is given to using Co(BF₄)₂.6H₂O, Co(acac)₂; Co(acac)₃. A preferred Ru source is Ru(acac)₃; [RuCl₂(benzene)]₂, [RuCl₂(p-cymene)]₂, RuCl₃×H₂O, RuBr₃xH₂O.

Ligands which are particularly preferably used are tetraphos (PP₃) or tris(2-(diphenylphosphino)phenyl)phosphine (L1).

In this preferred variant (in situ catalyst) of the process of the invention, the ligand is added in a substoichiometric or superstoichiometric amount to the metal source; the ratio of metal source: ligand is preferably 1:1 or with an excess of ligand.

Metal complexes of the general formula (Ia) which are very particularly preferably used in the process of the invention are, for example, [Fe(acac)(PP₃)]BPh₄), [Fe(acac)(PP₃)]BF₄, [Fe(ClO₄)(PP₃)]BPh₄, [Fe(ClO₄)(PP₃)] BF₄, [FeH(PP₃)]BPh₄, [FeH(PP₃)]BF₄, [FeH(H₂)(PF₃)]BPh₄, [FeH(H₂)(PP₃)]BF₄, [FeF(PP₃)]BPh₄ and [FeF(PP₃)]BF₄, [FeCl(PP₃)]BPh₄ and [FeCl(PP₃)]BF₄, [FeBr(PP₃)]BPh₄ and [FeBr(PP₃)]BF₄, and also FeF(L1)BPh₄.

The catalyst can be used as homogeneous or heterogenized metal complex. When the metal complex described is used as homogeneous complex, a suitable solvent should be used for carrying out the reaction. Suitable solvents for the reaction (decomposition of formic acid) are selected from the group consisting of formamides, ethers, esters, alcohols and carbonates, e.g. DMF, triglyme, diglyme, THF, dioxane, PEG and propylene carbonate. Preference is given to using THF, PEG and propylene carbonate as solvent in the homogeneous process according to the invention. The preferred propylene carbonate, in particular, has a series of advantages since it has a high boiling point and also a low toxicity and is known to be completely biodegradable.

In the production of a heterogenized complex, the SILP technology is particularly preferred, alongside other methods. Here, for example, a defined previously synthesized complex is dissolved in a suitable ionic liquid and applied to activated SiO₂. The powder obtained in this way is then preferably used for the reaction of the formic acid.

The hydrogen gas produced is virtually free of carbon monoxide and can be fed directly into a fuel cell which produces power. In addition, the hydrogen can be utilized in all internal combustion engines. In addition, the gas mixture produced, hydrogen and carbon dioxide, or the separated gases, can be utilized for chemical reactions. For use in an H₂/O₂ PEM fuel cell, the hydrogen gas can optionally be purified using an activated carbon filter.

The reaction can be carried out in an apparatus which allows continuous production of hydrogen. For this purpose, a stock vessel containing formic acid can be connected by means of a suitable pump to a reactor which contains the active catalyst system. The reaction is started by introduction of the formic acid and an H₂:CO₂ gas mixture (1:1) is obtained. This gas mixture can be reacted, for example, in an H₂/O₂ PEM fuel cell.

High activities with a TOF of more than 9000 h⁻¹ and a stable TON above 92 000 were able to be achieved with high selectivity (CO<10 ppm) when using a preferred in situ catalyst system composed of an Fe source and the ligand PP₃ in propylene carbonate as solvent.

When the preferred catalyst system is used according to the invention, it is possible to generate, for example, 0-3.3 liters of H₂/min/mmol of Fe. The values fluctuate depending on the amount of formic acid to be used, solvents, reactor volume, temperature and pressure.

The catalyst system which is preferably used according to the invention is thus equivalent to previous systems based on the use of noble metal-containing catalyst systems. In the present case, the reaction proceeds without additions of bases or other additives such as Co catalysts. In particular, the possibility of using propylene carbonate as biodegradable solvent also makes the reaction industrially interesting.

### EXAMPLES

### Example 1

### Preparation of the ligands L1-L3

| Designation | Formula |
|---|---|
| L1 | 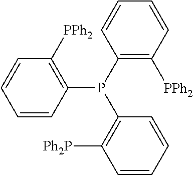 |
| L2 | 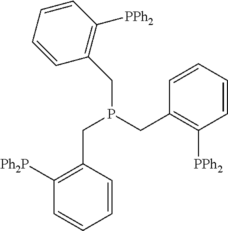 |
| L3 | 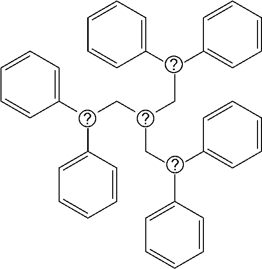 [SMILES: c1ccc(C(CC(CC(c2ccccc2)c2ccccc2)CC(c2ccccc2)c2ccccc2)c2ccccc2)cc1] |

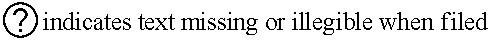

### 1a) Preparation of L1 (tris(2-(diphenylphosphino)phenyl)phosphine)

1.5 g (4.4 mmol) of (2-bromophenyl)diphenylphosphine are dissolved in 30 ml of absolute THF (tetrahydrofuran) under argon with magnetic stirring in a 100 ml three-neck flask provided with thermometer and reflux condenser. The mixture is cooled to −78° C. by means of a cold bath and, at this temperature, 3 ml of 1.6 N n-butyllithium in hexane (4.8 mmol) are added to the mixture by means of a dropping funnel over a period of 10 minutes. The mixture is stirred at this temperature for 30 minutes. 0.13 ml of phosphorus trichloride dissolved in 5 ml of absolute THF is subsequently added at this temperature over a period of 5 minutes. The reaction mixture is allowed to come to room temperature over a period of 1 hour while stirring, and is subsequently heated at reflux temperature (about 65° C.) for 1 hour. The solution is subsequently cooled and evaporated to dryness under reduced pressure. 30 ml of absolute toluene are added and 20 ml of water (degassed) are introduced. The toluene phase is washed three times with 20 ml of water and dried using magnesium sulfate. After filtration, the solution is evaporated to 10 ml under reduced pressure and admixed with 50 ml of absolute methanol. A white solid precipitates over a period of half an hour. This is the target product and is filtered off and dried under reduced pressure. The yield is 0.6 g (50%) of tris(2-(diphenylphosphino)phenyl)phosphine.

¹H-NMR (300 MHz, CD₂Cl₂ δ (ppm): 6.5-7.3 m, ¹³C-NMR (75 MHz, CD₂Cl₂ δ (ppm): 128.4-128.8 (m), 129.0 (d, J_{PC}=21 Hz), 133.9-134.3 (m); 135.1-135.5 (m) ³¹P-NMR (121 MHz, CD₂Cl₂) δ (ppm): −13.1-−14.5 (m, 3 P), −18.2-−23.5 (m, 1 P). HRMS: calculated for C₅₄H₄₂P₄: 814.22315; found: 814.221226.

### 1b) Preparation of L2 (tris(2-(diphenylphosphino)benzyl)phosphine

2.2 ml (3.5 mmol) of 1.6 N n-butyllithium in hexane are transferred under argon into a 100 ml three-neck flask provided with thermometer and reflux condenser. The hexane is taken off at room temperature under reduced pressure (2 torr). 20 ml of absolute ether and 0.6 ml of TMEDA are added. 1 g of diphenyl (o-methylphenyl)phosphine is then added at room temperature with magnetic stirring. Orange-colored crystals precipitate within a few minutes. The crystallization is allowed to progress for about 30 minutes and the supernatant solution is then filtered off, 15 ml of n-pentane are added and the mixture is cooled to −70° C. At this temperature, 0.11 ml (0.165 g, 1.2 mmol) of PCl₃ dissolved in 5 ml of pentane is added dropwise by means of a dropping funnel. The mixture is subsequently allowed to come to room temperature while stirring and 20 ml of absolute THF are added.

The solution is stirred for another 2 hours, the solvent is subsequently removed under reduced pressure and 20 ml of absolute toluene are added. The solution is washed three times with 10 ml of degassed water, dried over sodium sulfate and the toluene is subsequently removed under reduced pressure. The solution is taken up in 5 ml of methylene chloride, and 40 ml of MeOH are added; some brown precipitate precipitates and the solution is decanted off from this and the solution is evaporated. The product tris(2-(diphenylphosphino)benzyl)phosphine is obtained in 95% purity as a solid (yield=350 mg, 33%) ¹H-NMR (300 MHz, acetone d₆ δ (ppm): 7.5-6.5 (m, 42H), 3.62-3.58 8 m, 1.2; H), 3.2-3.17 (bs, 3.6; H), 2.15-2.0 (m, 1.2; H), ¹³C-NMR (75 MHz, acetone d₆ δ (ppm): 138 (d, JPC=12 Hz), 135-134 (m), 126.9 (d, J_{PC}=4 Hz), 68 (s), 26 (s) ³¹P-NMR (121 MHz, acetone d6) δ (ppm): −5.1 (q, Jₚₚ=23 Hz, 1 P), −15.4 (d, J_{PP}=23, 3 P). HRMS: calculated for C₅₇H₄₇P₄[M+−1]: 855.26227; found: 855.262506.

### 1c) Preparation of L3 tris((diphenylphosphino)methyl)amine

1.9 g (6.7 mmol) of bis(hydroxymethyl)diphenylphosphonium chloride, 0.12 g (2.2 mmol) of ammonium chloride, 1.9 ml of triethylamine and 25 ml of absolute methanol are heated under reflux (about 80° C.) under argon for 2 hours with magnetic stirring in a 100 ml three-neck flask provided with thermometer and reflux condenser. The target product precipitates as a white precipitate; after cooling, the mixture is filtered and the product is washed once with 8 ml of methanol. The yield is 3.27 g, 80%: ¹H-NMR (300 MHz, CD₂Cl₂ δ (ppm): 7.4-7.2 (m, 30H), 3.8 (d, J_{PH}=4.5 Hz, 6H), ¹³C-NMR (75 MHz, CD₂Cl₂ δ (ppm): 138.3 (d, J_{PC}=12.8 Hz), 133.5 (d, JPC=18.5 Hz), 128.9 (s), 68 (s), 128.6 (d, JPC=6.9 Hz), ³¹P-NMR (121 MHz, CD₂Cl₂) S (ppm): −28.7 (s). HRMS: calculated for C₃₉H₃₆NP₃[M]: 610.19769; found: 610.197315

### Example 2

### Preparation of the Metal Complexes K1-K9

| Designation | Gen. formula |
|---|---|
| K1 | [FeF(PP₃)]BPh₄ |
| K2 | [FeCl(PP₃)]BPh₄ |
| K3 | [FeBr(PP₃)]BPh₄ |
| K4 | [FeH(PP₃)]BPh₄ |
| K5 | [FeH(PP₃)]BF₄ |
| K6 | [FeH(H₂)(PP₃)]BPh₄ |
| K7 | [Fe(acac)(PP₃)]BPh₄ |
| K8 | [Fe(ClO₄)(PP₃)]BPh₄ |
| K9 | [FeF(L1)]BF₄ |

### Preparation of K1, [FeF(PP₃)]BPh₄

0.50 mmol of Fe(BF₄)₂*6H₂O (169 mg) and 0.55 mmol of tris[(2-diphenylphosphino)ethyl]phosphane (369 mg) are firstly introduced in a countercurrent of argon into a Schlenk vessel (50 ml). 10 ml of distilled THF were subsequently introduced into the flask in a countercurrent of argon. The solution was stirred at room temperature for about 2 hours. 1.5 eq. (257 mg) of NaBPh₄ were then added. The deep purple solution was subsequently evaporated to 5 ml under reduced pressure and admixed with 10 ml of distilled EtOH and stored overnight in a refrigerator (˜5° C.). The precipitated purple solid was then filtered off and washed with 4×2 ml of cold EtOH and 2×1 ml of n-hexane. The purple solid was subsequently dried at 10⁻³ mbar using a high-vacuum pump; m_{product}=428 mg (η=80%) HRMS: calculated for C₄₂H₄₂FeFP₄: 745.1565; found 745.1573.

### Preparation of K2, [FeCl(PP₃)]BPh₄

0.54 mmol of FeCl₂ (68.4 mg) and 0.59 mmol of tris[(2-diphenyl-phosphino)ethyl]phosphane (396 mg) are firstly introduced in a countercurrent of argon into a Schlenk vessel (50 ml). 50 ml of distilled EtOH were subsequently introduced in a countercurrent of argon into the flask. The solution was stirred under reflux for about 2 hours. 0.7 mmol (239 mg) of NaBPh₄ were then added. The deep purple solution was subsequently stored overnight in a refrigerator (˜5° C.). The precipitated purple solid was then filtered off and washed with 5×5 ml of H₂O and 5×5 ml of EtOH. The solid was then recrystallized from EtOH/H₂O/acetone (10/1/1). The purple solid (powder) was finally dried at 10-3 mbar using a high-vacuum pump; m_{product}=490 mg (η=84%) HRMS: calculated for C₄₂H₄₂FeClP₄: 761.1211; found 761.1271.

### Preparation of K3, [FeBr(PP₃)]BPh₄

0.50 mmol of Fe(Br)₂ (108 mg) and 0.55 mmol of tris[(2-diphenyl-phosphino)ethyl]phosphane (369 mg) are firstly introduced in a countercurrent of argon into a Schlenk vessel (50 ml). 20 ml of distilled EtOH were subsequently introduced in a countercurrent of argon into the flask. The solution was stirred at room temperature for about 2 hours. 1.5 eq. (257 mg) of NaBPh₄ were then added, resulting in precipitation of a dark deep purple solid. The precipitated solid was then filtered off and washed with 4×2 ml of cold EtOH and 2×1 ml of n-hexane. The purple solid was subsequently dried at 10⁻³ mbar using a high-vacuum pump; m_{product}=563 mg (η=94%) HRMS: calculated for C₄₂H₄₂FeBrP₄: 807.07534; found 807.07451.

### Preparation of K4, [FeH(PP₃)]BPh₄

0.67 mmol of Fe(BF₄)₂*6H₂O (226 mg) and 0.67 mmol of tris[(2-diphenyl-phosphino)ethyl]phosphane (450 mg) and 1.5 eq. of NH₄BPh₄ are firstly introduced in a countercurrent of argon into a Schlenk vessel (50 ml). 30 ml of distilled THF were subsequently introduced in a countercurrent of argon into the flask. The solution was cooled to −78° C. by means of a dry ice-ethanol suspension. After stirring for 3-6 hours, the solution was slowly warmed to room temperature. The deep orange/red solution was subsequently evaporated to ˜2 ml under reduced pressure and admixed with 15 ml of distilled EtOH and stored overnight in a refrigerator (˜5° C.). The precipitated orange solid was subsequently filtered off and washed with 5×5 ml of cold EtOH. The orange solid was subsequently dried at 10⁻³ mbar using a high-vacuum pump; m_{product}=538 mg (η=76%) HRMS: calculated for C₄₂H₄₃FeP₄: 727.16599; found 727.16478.

### Preparation of K5, [FeH(PP₃)]BF₄

0.22 mmol of Fe(BF₄)₂*6H₂O (75 mg) and 0.22 mmol of tris[(2-diphenyl-phosphino)ethyl]phosphane (150 mg) and 0.55 mmol of NaBPh₄ are firstly introduced in a countercurrent of argon into a Schlenk vessel (50 ml). 30 ml of distilled THF were subsequently introduced in a countercurrent of argon into the flask. The solution was cooled to −78° C. by means of a dry ice-ethanol suspension. After stirring for 3-6 hours, the solution was slowly warmed to room temperature. The deep orange/red solution was subsequently evaporated to ˜2 ml under reduced pressure and admixed with 15 ml of distilled EtOH and stored overnight in a refrigerator (˜5° C.). The precipitated orange solid was then filtered off and washed with 5×5 ml of cold EtOH. The orange solid was subsequently dried at 10⁻³ mbar using a high-vacuum pump; m_{product}=143 mg (η=80%) HRMS: calculated for C₄₂H₄₃FeP₄: 727.1660; found 727.1652.

### Preparation of K6, [FeH(H₂)(PP₃)]BPh₄

0.22 mmol of Fe(BF₄)₂*6H₂O (75 mg) and 0.22 mmol of tris[(2-diphenyl-phosphino)ethyl]phosphane (150 mg) and 0.55 mmol of NaBPh₄ are firstly introduced in a countercurrent of hydrogen into a Schlenk vessel (50 ml). 15 ml of distilled THF were subsequently introduced in a countercurrent of hydrogen into the flask. The solution was cooled to −78° C. by means of a dry ice-ethanol suspension. After stirring for 3-6 hours, the solution was slowly warmed to room temperature. The deep yellow/orange solution was subsequently evaporated to 2 ml under reduced pressure and admixed with 15 ml of distilled EtOH and stored overnight in a refrigerator (˜5° C.). The precipitated yellow solid was then filtered off and washed with 5×5 ml of cold EtOH. The yellow solid was dried in a countercurrent of H₂; m_{product}=187 mg=80%).

¹H-NMR (400 MHz, THF d₈ δ (ppm): −7.56 ppm (s, 2H), −12.47 ppm (AM₂Q, J(HP_{A})=45.1 Hz, J(HP_{M})=58.2 Hz, J(HP_{Q})=15.2 Hz), 1H), ¹³C-NMR (75 MHz, THF d₈ δ (ppm): 126.58-139.93 (m, 6 C), 29.05-32.84 (m, 1 C) ³¹P-NMR (121 MHz, THF d₈) δ (ppm): 89.9 (m, 3 P), 173.6 (m, 1 P).

### Preparation of K7, [Fe(acac)(PP₃)]BPh₄

0.50 mmol of Fe(acac), (127 mg) and 0.55 mmol of tris[(2-diphenyl-phosphino)ethyl]phosphane (369 mg) were firstly introduced in a countercurrent of argon into a Schlenk vessel (50 ml). 20 ml of distilled EtOH were subsequently introduced in a countercurrent of argon into the flask. The solution was stirred at 50° C. for about 3 hours. 1.5 eq. (240 mg) of NaBPh₄ were then added. The precipitated solid was then filtered off and washed with 4×2 ml of cold EtOH and 2×1 ml of n-hexane. The solid was subsequently dried at 10⁻³ mbar using a high-vacuum pump; m_{product}=310.6 mg (η=54%).

### Preparation of K8, [Fe(ClO₄)(PP₃)]BPh₄

0.30 mmol of Fe(ClO₄)₂ (76 mg) and 0.33 mmol of tris[(2-diphenyl-phosphino)ethyl]phosphane (222 mg) are firstly introduced in a countercurrent of argon into a Schlenk vessel (50 ml). 5 ml of distilled THF were subsequently introduced in a countercurrent of argon into the flask. The solution was stirred at room temperature for about 24 hours. 0.4 mmol (136 mg) of NaBPh₄ were then added. The deep purple solution was subsequently evaporated to ˜2 ml under reduced pressure and admixed with 5 ml of distilled EtOH and stored overnight in a refrigerator (˜5° C.). The precipitated violet solid was then filtered off and washed with 4×2 ml of cold EtOH and 2×1 ml of n-hexane. The purple solid was subsequently dried at 10⁻³ mbar using a high-vacuum pump; m_{product}=150 mg (η=43%).

### Preparation of K9, [FeF(L1)]BF₄

0.275 mmol of Fe(BF4)₂×6 H₂O (93 mg) and 0.31 mmol of tris[(2-diphenyl-phosphino)phenyl]phosphane (225 mg) are firstly introduced in a countercurrent of argon into a Schlenk vessel (50 ml). 20 ml of distilled THF were subsequently introduced in a countercurrent of argon into the flask. The solution was stirred at 20° C. for about 3 hours. The THF was then distilled off under reduced pressure, the solid was taken up in 5 ml of CH₂Cl₂ and covered with a layer of 40 ml of Et₂O. A deep violet solid precipitated overnight; this is filtered off and dried under reduced pressure and represents the target product (including 1 equivalent of CH₂Cl₂ as solvent of crystallization). Yield=186 mg (80%).

### Example 3

### Experimental Setup and Procedure for the Decomposition of Formic Acid

Description of the experimental setup for automatic determination of gas volumes: Boddien et al. GIT 2010, 8, 576.

### Example 4

Obtaining hydrogen from formic acid utilizing the metal catalyst systems K1 and K4-K7

### Reaction Conditions:

5.3 μmol of catalyst (100 ppm) in 2 ml of HCO₂H, 3 ml of propylene carbonate, T=40° C., measured using a gas burette, (H₂:CO₂ 1:1)

| Designation | Catalyst | TON 2 h | TON 3 h |
|---|---|---|---|
| K1 | [FeF(PP₃)]BPh₄ | 838 | 1243 |
| K4 | [FeH(PP₃)]BPh₄ | 487 | 724 |
| K5 | [FeH(PP₃)]BF₄ | 745 | 1135 |
| K6 | [FeH(H₂)(PP₃)]BPh₄ | 727 | 1129 |
| K7 | [Fe(acac)(PP₃)]BPh₄ | 486 | 744 |

### Example 5

Obtaining hydrogen from formic acid with in situ generation of the metal catalyst system using various metal sources and the ligand tris[(2-diphenylphosphino)ethyl]phosphine (PP₃); MW 670.69052, melting point 134-139° C., commercially available from Acros or Sigma Aldrich.

### Reaction Conditions:

5.3 μmol of metal precatalyst (100 ppm) in 2 ml of HCO₂H, 3 ml of propylene carbonate, 10.6 μmol of PP₃ (2 eq.), T=60° C., measured using a gas burette, (H₂:CO₂ 1:1)

TABLE 1
Various metal sources for the production
of hydrogen from formic acid.

| | | V_{3 h} (H₂ + CO₂) | |
|---|---|---|---|
| No. | Metal precatalyst | [ml] | TON_{3 h} |
| 1 | Fe(BF₄)•6H₂O | 1684 | 6512 |
| 2 | Co(BF₄)₂•6H₂O | 51 | 197 |
| 3 | Ru(acac)₃ | 654.5 | 2521 |

TABLE 2
Various iron sources for the production
of hydrogen from formic acid.

| | | η_{CAT} | V(H₂ + CO₂) (3 h) | |
|---|---|---|---|---|
| No. | Fe catalyst | [μmol] | [ml] | TON (3 h) |
| 1 | Fe(BF₄)₂•6H₂O | 5.27 | 1684 | 6512 |
| 2 | Fe(acac)₂ | 5.31 | 1510 | 5794 |
| 3 | Fe(acac)₃ | 5.32 | 1839 | 7042 |
| 4 | Fe(ClO₄)₂ | 5.29 | 954 | 3674 |
| 5 | Fe(ClO₄)₃ | 5.3 | 1339 | 5148 |

### Example 6

Selective production of hydrogen from formic acid with in situ generation of the metal catalyst system using the iron(II) source Fe(BF₄)₂×6 H₂O; CAS number: 13877-16-2, molecular weight: 337.55, commercially available from Tanumal Chemical Complex Bldg. OK 74015 USA and various ligands.

| Ligand | Temperature | V_{3 h} [ml] | TON_{3 h} |
|---|---|---|---|
| L1 | 60 | 69 | 267 |
| L1 | 40 | 38 | 71 |
| L2 | 40 | 2 | 8 |
| L3 | 40 | 3 | 12 |

5.3 μmol of Fe(BF₄)₂.2H₂O (100 ppm), 2 ml of HCO₂H, 3 ml of propylene carbonate, 10.6 mmol of ligand.

### Example 7

Selective production of hydrogen from formic acid with in situ generation of the metal catalyst system using the iron(II) source Fe(BF₄)₂×6 H₂O; CAS number: 13877-16-2, molecular weight: 337.55, commercially available from Tanumal Chemical Complex Bldg. OK 74015 USA and the ligand tris[(2-diphenyl-phosphino)ethyl]phosphine (PP₃) in various solvents.

### Reaction Conditions:

5.3 μmol of metal precatalyst Fe(BF₄)₂*6H₂O (100 ppm) in 2 ml of HCO₂H, 3 ml of propylene carbonate, 10.6 mmol of PP₃ (2 eq.), T=60° C., measured using a gas burette, (H₂:CO₂ 1:1)

TABLE 3

| Solvent | V3 h/ml | TON 3 h |
|---|---|---|
| Dioxane | 1506 | 5817 |
| THF | 1567 | 6053 |
| DMF | 104 | 402 |
| Propylene carbonate | 2188 | 8454 |
| PEG Mn ~200 | 726 | 2803 |
| PEG Mn ~285-315 | 985 | 3806 |

### Example 8

Selective production of hydrogen from formic acid with in situ generation of the metal catalyst system using the iron(II) source Fe(BF₄)₂×6H₂O and the ligand tris[(2-diphenylphosphino)ethyl]phosphine (PP₃) at various temperatures.

### Reaction Conditions:

5.3 μmol of Fe(BF₄)₂.6H₂O, 2 or 4 eq. of PP₃ in 20 ml of propylene carbonate, 2 ml of HCO₂H, determination of the TOF for the first half hour, TOF calculated using factor, gas volume was measured using a 500 ml manual gas burette and analyzed by means of GC (H₂:CO₂=1:1).

TABLE 4

| | Concentration of | Concentration of | T | TOF |
|---|---|---|---|---|
| No. | Fe(BF₄)₂•6H₂O [ppm] | PP₃ [ppm] | [° C.] | [h⁻¹] |
| 1 | 100 | 200 | 60 | 1922 |
| 2 | 100 | 400 | 60 | 2018 |
| 3 | 100 | 400 | 80 | 8136 |
| 4 | 50 | 400 | 80 | 9425 |

### Example 9

### Long-Term Test

Continuous decomposition of formic acid by means of Fe(BF₄)₂ 6H₂O and 4 eq. of PP₃. In the experiment, 74 mmol of Fe precatalyst and 4 eq. of PP₃ were introduced into 50 ml of PC. The reaction vessel was subsequently heated to 80° C. During the experiment, 0.27±0.04 ml·min⁻¹ of formic acid were added.

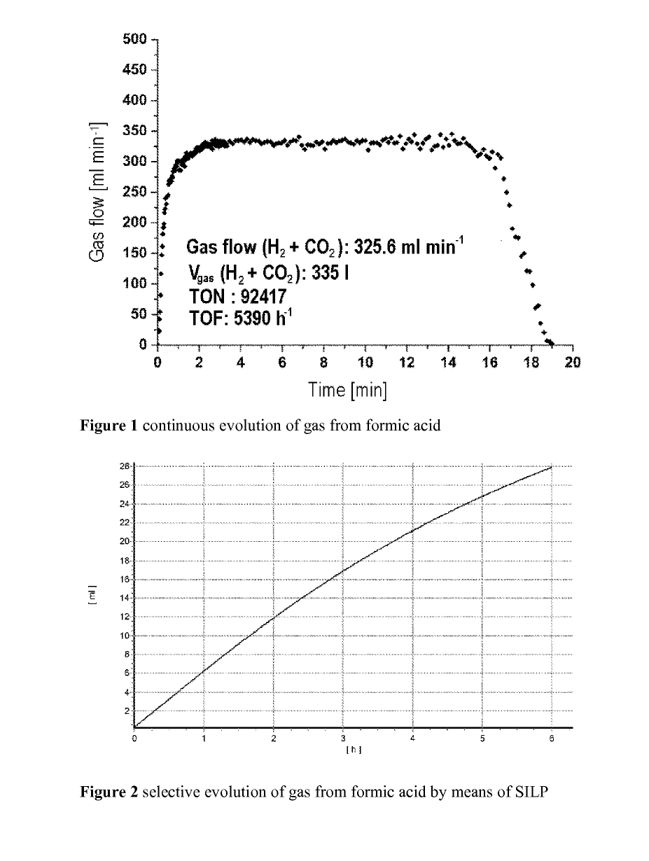

Under the experimental conditions, 335 liters of gas were able to be evolved over 16 hours at an average gas flow of 325.6 ml·min⁻¹. An average TOF of 5390 h⁻¹ and a TON of 92 417 were achieved here (see FIG. 1).

### Example 10

Production of a heterogenized SILP catalyst for the selective decomposition of formic acid.

### SILPI

0.25 mmol (84.2 mg) of Fe(BF₄)₂.6H₂O and 0.25 mmol (168 mg) of tris[(2-diphenyl-phosphino)ethyl]phosphane are introduced into a 50 ml round-bottomed flask with tap. 10 ml of THF were subsequently introduced in a countercurrent of argon and the reaction solution was stirred at room temperature for 30 minutes. 0.15 g of BMIM (1-butyl-3-methylimidazolium tetrafluoroborate) and 1.5 g of activated (600° C., 2 h, 10⁻³ mbar) silica (SiO₂) were then added. The solution was subsequently evaporated to dryness on a rotary evaporator. Finally, the purple-colored solid was dried overnight in a high vacuum.

In an illustrative experiment, 2 ml of HCO₂H, 5 ml of PC and 20 mg of SILPI were placed in a reaction vessel. The solution was heated to 40° C. and the gas mixture formed was analyzed by means of an automatic burette and GC (see also FIG. 2).
V₃ₕ[ml] Activity [mmol
   of H₂·h⁻¹·g⁻¹]
16.86 5.68

1-13. (canceled)

14. A process for obtaining hydrogen selectively by catalytic decomposition of formic acid which comprises liberting hydrogen selectively from formic acid at temperatures of from 0° C. to 100° C. using a catalyst system which consists of a transition metal salt and a tripodal tetradentate ligand, where the transition metal is selected from the group consisting of Ir, Pd, Pt, Ru, Rh, Co and Fe.

15. The process as claimed in claim 14, wherein the catalyst system is a metal complex consisting of a cation and anion or a neutral metal complex having the general formula (Ia) or (Ib),
[M(X)ₘ(L)ₙ]⁺Y⁻ (Ia)
M(X)ₘ(L)ₙ (Ib)
where
M is a transition metal selected from the group consisting of Ir, Pd, Pt, Ru, Rh, Co and Fe;
X is selected from the group consisting of N₂, H₂, H, CO, CO₂, H₂O, halide, acetylacetonate (acac⁻), perchlorate (ClO₄²⁻) and sulfate (SO₄²⁻);
m is 1-6;
L is a tripodal ligand of the general formula (II) 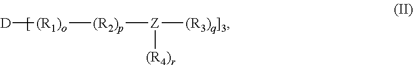
where
D and Z are identical or different and are each selected from the group consisting of N, O, P and S;
o and p are identical or different and are 0, 1, 2 or 3;
R₁ and R₂ are identical or different and are each selected from the group consisting of alkyl (C1-C6), cycloalkyl (C3-C10) and aryl;
R₃ and R₄ are identical or different and are each selected from the group consisting of alkyl (C1-C6), cycloalkyl (C3-C10), aryl and heteroaryl;
q and r are identical or different and are each 1 or 2;
where D and/or Z can be coordinated to the metal;
n is 1 or 2; and
Y⁻ is a monovalent anion selected from the group consisting of halides,
P(R)₆⁻, S(R)₆⁻, B(R)₄⁻, where R is an alkyl (C1-C6), aryl or halogen radical, triflate and mesylate anions.

16. The process as claimed in claim 15, wherein
M is Ru, Co or Fe;
m is 1, 2 or 3; and
Y⁻ is BF₄⁻ or BPh₄⁻.

17. The process as claimed in claim 14, wherein the transition metal M is Co or Fe.

18. The process as claimed in claim 14, wherein the transition metal M is Fe.

19. The process as claimed in claim 14, wherein D in the general formula (II) is N or P.

20. The process as claimed in claim 14, wherein Z in the general formula (II) is P.

21. The process as claimed in claim 14, wherein the catalyst system comprises a ligand L of the general formula (II) which is selected from the group consisting of
a) tetraphos [PP₃],
b) tris(2-(diphenylphosphino)phenyl)phosphine, [L1],
c) tris(2-(diphenylphosphino)benzyl)phosphine, [L2], and
d) tris((diphenylphosphino)methyl)amine, [L3].

22. The process as claimed in claim 14, wherein the catalyst system is used as homogeneous complex in a solvent.

23. The process as claimed in claim 14, wherein the catalyst system is used as homogeneous complex in a solvent selected from the group consisting of formamides, ethers, esters, alcohols and carbonates.

24. The process as claimed in claim 14, wherein the catalyst system is generated in situ.

25. The process as claimed in claim 14, wherein the catalyst system is generated in situ using an Fe(0), Fe(II), Fe(III) source.

26. The process as claimed in claim 14, wherein the catalyst system comprises a metal complex selected from the group consisting of [Fe(acac)(PP₃)]BPh₄, [Fe(acac)(PP₃)]BF₄, [Fe(ClO₄)(PP₃)]BPh₄, [Fe(ClO₄)(PP₃)]BF₄, [FeH(PP₃)]BPh₄, [FeH(PP₃)]BF₄, [FeH(H₂)(PP₃)]BPh₄, [FeH(H₂)(PP₃)]BF₄, [FeF(PP₃)]BPh₄, [FeF(PP₃)]BF₄ and [FeF(L1)]BPh₄.

27. The process as claimed in claim 14, wherein the catalyst system is used as heterogenized complex.

28. The process as claimed in claim 14, wherein the reaction is carried out at a temperature of from 20 to 100° C.

29. The process as claimed in claim 14, wherein the reaction is carried out at a temperature of from 25 to 80° C.

30. The process as claimed in claim 14, wherein no bases and other additives are added.

31. The process as claimed in claim 14, wherein the process is controlled by setting of temperature, pressure, irradiation with light and/or amount of formic acid.
